(19) United States
(12) Patent Application Publication
(10) Pub. No.: US 2011/0171534 A1
(43) Pub. Date: Jul. 14, 2011

(54) Long lasting high current density charging & discharging, temperature-resistant batteries and related methods

(76) Inventors: Ernest Paul Lampert, Carlsbad, CA (US); Stanley Sims, N. Las Vegas, NV (US)

(21) Appl. No.: 12/657,128

(22) Filed: Jan. 14, 2010

(51) Int. Cl. H01M 2/16

(52) U.S. Cl. 429/246

(57) ABSTRACT

Secondary batteries are disclosed, which comprise a separator of dielectric material permeable to ion flow in combination with aligned Carbon or Zirconium nanotubes extending between an anode and a cathode comprised of Zirconium and aligned nanotubes and having high surface areas, and one or two electrolytes comprising Bismuth in colloidal suspension and when two are used they are confined to two independent chambers to prevent comingling.

### FIELD OF THE INVENTION

The present invention relates generally to long-lasting, high current density charging & discharging, temperature-resistant batteries and related methods, and more particularly to batteries and methods using nanotubes to facilitate ionic flow, Zirconium electrodes and Bismuth electrolytes.

### BACKGROUND

In the past, one of the most utilized batteries has been the lead-acid battery. The present invention overcomes or alleviates problems of the past in respect to lead-acid and other types of batteries.

All lead-acid batteries typically comprise of electrode plates, with a separator between the anode and cathode plates, creating individual cells. The lead-acid battery also uses an electrolyte. The surfaces of plates and separators are contiguous with the electrolyte. The separator functions to prevent the electrode plates from coming in contact with each other and shorting out.

The lead-acid battery functions by transporting positive ions and negative ions to and from the two electrode plates through the electrolyte. The electrolyte is a weak acid solution comprised of sulfuric acid (H₂SO₄) and water. The chemical reaction from charging and discharging is Pb+PbO₂+2 H₂ SO₄⇄2 Pb SO₄+2 H₂O. This is a typical oxidation/reduction equation (Lead+Lead Oxide+Sulfuric Acid⇄Lead Sulfate+Water).

The lead electrode plate creates lead oxide, which is suspended, in a charged state, in the electrolyte. The lead oxide reacts with the sulfuric acid by oxidation to create lead sulfate in the water-acid solution. The lead sulfate, due to many cycles of charging and discharging, eventually precipitates out of solution and accumulates in the bottom of the battery, as dross. This chemical reaction is a major drawback to the lead-acid battery, which shortens the life of the battery. Also, the lead-acid battery is unable to withstand high temperatures.

### BRIEF SUMMARY AND OBJECTS OF THE PRESENT INVENTION

In brief summary, the present invention comprises long-lasting, high current density charging & discharging, temperature-resistant secondary batteries, and related methods, which overcome or alleviate battery problems of the past and provides batteries and methods using nanotubes, to facilitate ionic flow, Zirconium electrodes and Bismuth electrolytes.

It is a primary object of the present invention is to provide long-lasting, high current density charging & discharging temperature-resistant secondary batteries and related methods, which solves or alleviates battery problems of the past.

Another paramount object is to fabricate and provide secondary batteries having one or more of the following characteristics: comprising at least one separator disposed between an anode and a cathode, the separator further comprising a temperature resistant dielectric material permeable to ion flow in combination with nanotubes to enhance the ion flow; Carbon or Zirconium nanotubes in a separator, with the nanotubes oriented to be parallel to ion flow through the separator; a separator of dielectric material, including ceramics, polymers and fiber composites, with oriented and aligned nanotubes associated therewith, being formed as a slurry, cured into a solid and sintered; two electrolytes respectively confined to two independent chambers to prevent comingling; electrodes comprised of Zirconium, including Zirconium metal isotopes, and associated with nanotubes; electrodes comprised of high surface area sponge or textured (patterned) plates and associated with nanotubes; electrolytes comprised of Bismuth in colloidal suspension, including those in different ionic oxidation states, which are associated with nanotubes and/or nanosized powders, which nanotubes are of Carbon or Zirconium.

These and other objects and features of the present invention will be apparent from the detailed description taken with reference to the accompanying drawing.

### BRIEF DESCRIPTION OF THE DRAWINGS

FIG. 1 is a diagrammatic perspective representation of a battery electrode, for use as an anode and/or a cathode, in accordance with principles of the present invention, the electrode being depicted as a plate in rectangular form;

FIG. 2 is a diagrammatic perspective representation of a cylindrical electrode plate, in accordance with principles of the present invention, for use as an anode and/or a cathode;

FIG. 3 is a diagrammatic fragmentary representation, in perspective in accordance with principle of the present invention of a battery separator, shown in rectangular form;

FIG. 4 is a diagrammatic perspective representation of a battery cell, constructed in accordance with principles of the present invention;

FIG. 5 is a vertical cross-section through the single battery cell of FIG. 4; and

FIG. 6 is a horizontal cross-section through a circular single cell battery, fabricated in accordance with principles of the present invention.

### DETAILED DESCRIPTION OF THE ILLUSTRATED EMBODIMENTS

The electrodes of the present invention is different from those of the lead/acid battery in the following ways: the use of Zirconium electrode plates, which provides a more durable material to hold ions and does not deteriorate in the chemical reaction, Zirconium providing a very long life battery that doesn't accumulate dross in the bottom of the battery, the configuration of the electrode plates being of any suitable shape, such as rectangular, cylindrical and annular; use of Zirconium electrode plates can resist very high operating temperatures Zirconium metal is technically an alloy because it contains various trace metals, such as Hafnium; use of Zirconium isotopes can be utilized as the electrode plates, including 96 Zr, 94 Zr, 93 Zr, 92 Zr, 91 Zr, 90 Zr, 89 Zr and 88 Zr; use of Zirconium in a sponge or patterned configuration to significantly increase the surface area allowing the present battery to have increased ion storage capability; when used, 96 Zr emits BETA particles, which are electrons into the battery, providing a charging benefit; use of Carbon, preferably pure Carbon at 3.348 MeV; Zirconium nanotubes grown on or infused into the electrodes, which provides increased surface area for ion storage and transport.

The separators of the present invention are distinct. Fundamentally, the purpose of a separator is to prevent the contact between the electrode plates, which prevents the electrode plates from shorting out. The separator is comprised of a dielectric material that does not restrict ionic flow therethrough. The separator is thus permeable only to ions. The separator also accommodates the electrolyte coming in contact with surfaces of the electrodes. However, the present separator may, in some embodiments, provide an additional function, i.e. keeps separate a first electrolyte of one oxidation state on one side of the separator from a second electrolyte of a second oxidation state on the other side of the separator. Thus, in effect, a seal is formed between two separate electrolyte chambers of a battery cell. Thus, the electrolyte chambers are each sealed on all four sides to prevent the two electrolytes from coming together or comingling, with the separator being in the center of the two chambers also sealing one side of each chamber. Each separator is desirably associated with Carbon and/or Zirconium nanotubes. The nanotubes may be mixed into separator material while in a slurry liquid state before being cured into a solid state and sintered.

The nanotubes associated with the separator are pre-made individually and are electrostatic or magnetically aligned in a direction normal to the separator surfaces which are contiguous with the electrolytes, i.e. in the direction of ion and electron flow through the separator. The separators may be comprised of ceramic or polymeric separator materials. Preferably nanotubes are mixed into the ceramic or polymer materials, while in a liquid state or as a slurry during formation of the separator. The nanotubes are aligned in the slurry state and held in alignment during curing using magnetic or electrostatic forces. An inert gas flow, such as argon, may be used to keep the nanotubes open.

The electrolytes of the present invention preferably comprise a Bismuth compound, preferably dissolved into a colloidal suspension, although other suitable commercially available electrolytes can be used. Carbon and/or Zirconium nanotubes and/or activated Carbon or Zirconium nanosized powders may also comprise the electrolytes. The Bismuth electrolyte, BiSO₂HSO₄ for example, is available in oxidation states of +3, and +5 (charged ionic species). Sulfuric acid, hydrochloric acid or nitric acid may be used. Boron is used to chemically shim and stabilize the solutions, by titration. Bismuth electrolyte oxidation state +3, when used, is placed on the cathode side of the cell chamber and the +5 on the anode side. The two electrolytes are separated and sealed from each other in two electrolyte chambers. The purpose of mixing Carbon and/or Zirconium nanotubes and/or activated powders into the Bismuth electrolyte is to facilitate increased ion flow between the anode and cathode. The Bismuth electrolytes, filled with nanotubes or nanosized activated powders, are maintained in the colloidal suspension, which prevents the particles from precipitating out of solution.

Electric power storage devices of the present invention provide the benefits of a rechargeable battery with high current density per Kg and available high charge/discharge rates. Nanotubes are used in association with the anode and cathode electrode plates, which plates comprise Zirconium metal sponge or Zirconium patterned material creating a very high surface area. Dielectric separators are also associated with aligned nanotubes to increase ion flow through the separator and between the electrodes. The Bismuth electrolyte also includes nanotubes in colloidal suspension. This further increases the ion exchange during charging and discharging the battery.

Zirconium metal electrode plates are corrosion resistant, can handle high operating temperatures and provide for a long useful life. The battery cell is not damaged by deep discharges or high charging rates. Carbon or Zirconium nanotubes are formed individually by use of a vacuum furnace or by electrostatically growing the nanotubes. The electrodes may comprise very thin or foil plates. Activated nanotube powders can also be electrostatically caused to adhere to the electrode plates.

Separators with Carbon and/or Zirconium nanotubes fused within the matrix is contemplated by the present invention. The nanotubes of the separator are aligned perpendicular to the electrolyte-engaging surfaces of the separator. Ions flow through the separator between the electrode plates. The separator acts as a barrier to electrolyte flow between the electrode plates. The nanotubes of the separator act as a conduit to increase the ion flow between the electrode plates.

The invention further comprises mixing nanotubes into the electrolyte. The electrolyte is preferably a Bismuth colloidal suspension infused with nanotubes to increase the efficiency of the ion flow between the anode and the cathode and reduce internal resistance during high charge and discharge rates. Doping the anode or cathode with Cobalt or another similar material helps start current flow. Zirconium electrode plates allow for operation at high temperatures and obviates explosions while avoiding current densities reductions caused by deep discharging.

Rechargeable batteries according to the present invention do not start aging and discharging from the date of manufacturing, but have unlimited shelf life. Long storage periods and deep discharging events do not shorten the useful life of the present batteries. Isotopes of Zirconium may be used, which continually emits electrons into the battery, therefore slowly recharging the battery. 96 Zr, for example, can be safely used to recharge the battery, while in storage or in operation.

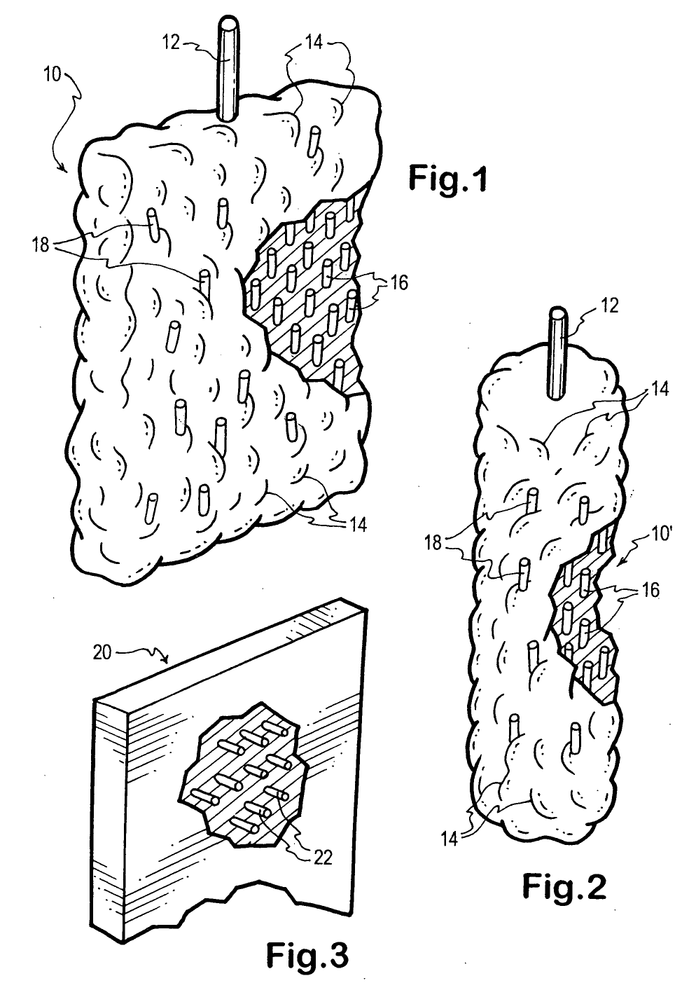

With reference now to the drawings, wherein like numerals are used to designate like parts throughout, FIG. 1 illustrates a rectangular electrode plate, for use either as an anode or a cathode, which is generally designated 10. Electrode plate 10 comprises a single integrated terminal 12, although multiple terminals can be used, either in conjunction with a rechargeable battery cell or a multi-cell secondary (rechargeable) battery. When the terminal 12 comprises an anode or cathode battery terminal formed of Zirconium, that terminal may be doped with Cobalt or other transitional element to create a polarity between the anode and cathode to help start current flow. The electrode 10 comprises Zirconium, which typically includes inconsequential amounts of other material, such as 1-3% by weight of Hafnium.

The Zirconium electrode 10 may comprise sponge metal material. Zirconium is a hexagonal crystalline material which withstands very high temperatures, is resistant to corrosion and yet strong and flexible. Zirconium may be utilized as electrodes in thin sections or foils, when appropriate. In lieu of Zirconium sponge material, the electrode 10 may comprise a patterned Zirconium metal. Both sponge and patterned Zirconium dramatically increase the surface area of the electrode 10, allowing the electrode to have enlarged ion storage capacity. The enlarged surface area is diagrammatically depicted in FIG. 1 and designated by numeral 14.

As also shown in FIG. 1, the electrode 10, also comprises nanotubes 16 and/or nanotubes 18. Nanotubes 16 are illustrated as being infused into the material comprising electrode 10 and as being oriented in the direction of ion flow. Nanotubes 18 are illustrated as being grown on or attached to the exterior of the electrode 10, but also oriented in the direction of ion flow. Nanotube alignment can be achieved, after the nanotubes are formed by use of a vacuum furnace or electrostatically, magnetically or electrostatically. Either Carbon nanotubes or Zirconium nanotubes may be utilized. As an alternative, nanosized activated powders may also be electrostatically applied to the electrode 10. The nanotubes accommodate displacement of positive and negative ions, along with ion charges found in the electrolyte in the direction of ions, which allows rapid diffusion of ions into and out of the active material comprising the electrode.

Isotopes of Zirconium can also be used to comprise electrode 10. This includes 96 Zirconium, which decays with a —B —B (two electrons) and is an isotope which assists in recharging the associated battery cell. Besides 96 Zirconium, 88-94 Zirconium isotopes can also be used to comprise the electrode 10.

In addition, the electrode 10 may comprise compounds of Zirconium including but not limited to Zr Br₃, Zr Br₄, ZrC, Zr (OH)₄, Zr F₄, Zr CL₂, ZrCL₄, Zr I₂, Zr I₃, Zr I₄, ZrH₂, ZrO₂, ZrS₂, ZrTe₂ and ZrN.

For electrode purposes, the Zirconium may also include various amphibole materials, i.e. a group of minerals, such as anthophyllite, tremolite, actinolite and hornblende, which comprise crystalline structures involving a silicate chain and generally containing three groups of metal ions, large ions comprising sodium and calcium, intermediate ions being chiefly bivalent iron, magnesium and manganese and ions chiefly silicone with some aluminum and rarely ferric iron.

With reference to FIG. 2, a cylindrical electrode plate 10 is illustrated which is comprised of Zirconium material, a terminal 12, infused nanotubes of 16 Carbon or Zirconium and attached nanotubes of Carbon or 10 Zirconium, all nanotubes being aligned in the direction of ion flow. Electrode 10 may be utilized as either an anode or a cathode.

As illustrated in FIG. 6, electrodes in accordance with the present invention may be annular, if desired. The shape and size of electrodes in accordance with the present invention will be selected by those skilled in the art so as to function appropriately and to fit within the confines of a casing enclosing a battery cell or battery of the size desired.

Reference is now made to FIG. 3, which illustrates, in fragmentary perspective a rectangular dielectric separator, generally designated 20. The dielectric separator 20 may be formed of commercially available materials such as ceramics, polymers, and/or fiber-based composite materials of the type heretofore used to form battery cell separators. Ceramic clays such as marilonite, taconite and bentonite mixed with a suitable polymer filler may be used to form the separator. Infused into the matrix of the separator 20 are Carbon or Zirconium nanotubes 22, magnetically or statically aligned so as to be parallel to the direction of current flow through the separator between the two electrodes of the battery cell. While other processes can be used, it is presently preferred that the material of which the separator 20 is comprised initially in the form of a slurry, placed in a suitable mold for curing and into which the nanotubes are dispersed and magnetically or statically aligned in the slurry in the direction shown in FIG. 3, after which the slurry is cured from liquid to solid state and sintered at a high temperature in a vacuum oven, all while the Carbon or Zirconium nanotubes 22 are retained in their aligned position parallel to the direction of current flow.

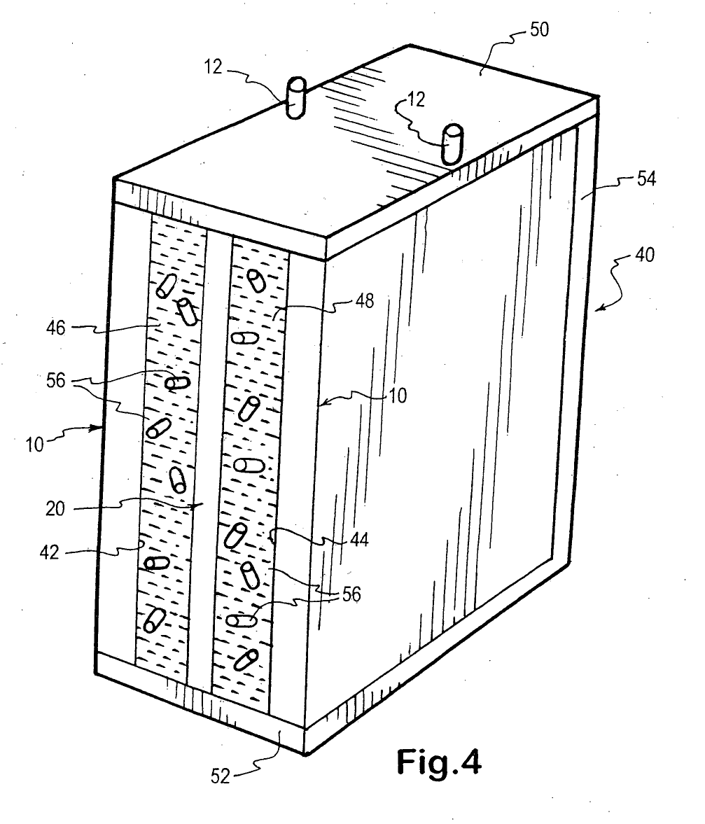

Reference is now made to FIG. 4, which illustrates a secondary battery cell 40, with the sides and one end of an encasement container being removed for clarity of illustration. The battery cell 40 of FIG. 4 comprises an anode 10, a cathode 10, a separator 20 interposed between the cathode and anode as well as two electrolyte chambers 42 and 44 in which a first electrolyte 46 and a second electrolyte 48 are respectively contained. The electrolyte chambers 42 and 44 are sealed by top and bottom encasement members 50 and 52, a back encasement member 54 and a removed front encasement member. Thus, in the embodiment 40 illustrated in FIG. 4, the electrolyte 46 is isolated from the electrolyte 48, but both accommodate ion flow through the separator 20.

While the electrolyte 46 and the electrolyte 48 may be identical, they may also be different, as explained below. It is preferred that electrolytes 46 and 48 be in colloidal suspension in which Carbon or Zirconium nanotubes 56 are dispersed to assist in carrying ions between the battery electrode plates. Nanosized powders can also be used separately or jointly with nanotubes in the Bismuth colloidal electrolyte.

The principle component of the electrolyte is Bismuth, preferably in a high viscosity or gel form. Bismuth sulfate, Bismuth sulfite and Bismuth hydrosulfate BiSO₂H₂O₄ may be used. The utilization of Bismuth accommodates faster charging and discharging cycles of the battery cell.

Bismuth may be in compound form, appropriate compounds comprising boron, bromine, barium, Carbon and sulfur. The electrolyte provides for high current density per kilogram flow during charging and discharging cycles.

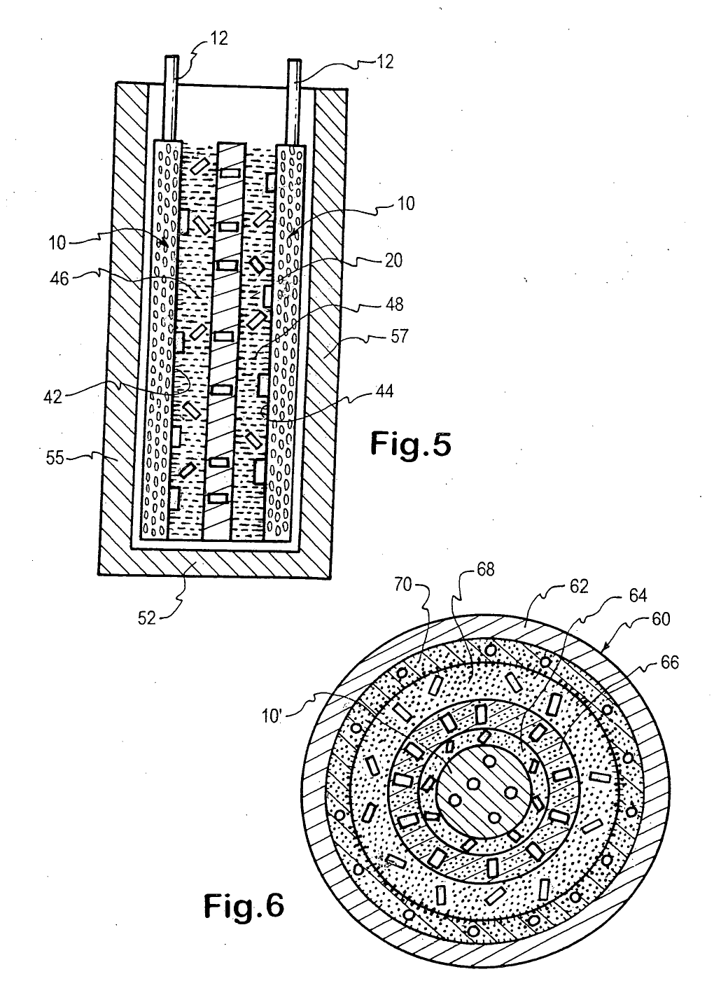

A vertical cross-section of the battery cell of FIG. 4 is illustrated in FIG. 5, with side enclosure panels 55 and 57 being shown but with the top enclosure member 50 being removed.

Electrolytes 46 and 48 may be two separate formulas, maintained separately in electrolyte chambers 42 and 44, as best determined by those skilled in the art. The Bismuth electrolyte, BiSO₂H₂O₄ for example, is available in oxidation states of +3, and +5 (charged ionic species). Bismuth electrolyte oxidation state +3, when used, is placed on the cathode side of the cell chamber and the +5 on the anode side. The two electrolytes are separated and sealed from each other in two electrolyte chambers 42 and 44.

Reference is now made to FIG. 6, which illustrates a single cell rechargeable battery, generally designated 60 fabricated in cylindrical form consisting of, at the center, cylindrical electrode 10 and a series of contiguous and concentric annular layers surrounding the electrode 10, ending with encasement layer 62 of the type conventional used in enclosing commercially available batteries. Annulus 64 comprises previously described electrolyte 46, while layer 66 comprises a separator of the type described in conjunction with FIG. 4 (separator 20).

Layer 68 comprises a second electrolyte of the type described in conjunction with FIG. 4 (electrolyte 48), while layer 70 comprises a second electrode. Layers 62, 66, and 70 may be formed using standard metal rolling techniques.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

What is claimed and desired to be secured by Letters Patent is:

1. A secondary battery comprising: at least one electrolyte; at least one anode plate at least one cathode plate; at least one separator having a surface, the separator being disposed between the anode plate and the cathode plate and comprising a temperature resistant dielectric material permeable to ion flow in combination with nanotubes to enhance ion flow.

2. A secondary battery according to claim 1 wherein the nanotubes are selected from the group consisting of Carbon and Zirconium.

3. A secondary battery according to claim 1 wherein the nanotubes are disposed essentially perpendicular to the surface of the separator and in a direction parallel to ion flow through the separator.

4. A secondary battery according to claim 3 wherein the perpendicularity is magnetically or electrostatically achieved.

5. A secondary battery according to claim 1 wherein the nanotubes and the dielectric material comprising the separator are first collectively placed in the form of a slurry with the nanotubes dispersed in the dielectric material, with the slurry and nanotubes being cured into a solid and sintered thereafter.

6. A secondary battery according to claim 1 wherein the dielectric material comprising the separator is selected from the group consisting of ceramic and polymer materials.

7. A secondary battery according to claim 1 wherein the at least one electrolyte comprises two electrolytes confined respectively to separate chambers with comingling of the two electrolytes being prevented by the separator.

8. A secondary battery comprising: at least one electrolyte; at least one anode comprised of Zirconium and having a surface; at least one cathode comprised of Zirconium and having a surface; at least one separator, the separator being disposed between the anode and the cathode.

9. A secondary battery according to claim 8 wherein the anode and the cathode both also comprise nanotubes.

10. A secondary battery according to claim 8 wherein the Zirconium of at least one of the anode and the Zirconium of the cathode comprises at least one Zirconium metal isotope selected from the group consisting of 96Zr, 94Zr, 93Zr, 92Zr, 91Zr, 90Zr, 89Zr, and 88Zr.

11. A secondary battery according to claim 10 wherein the battery is rechargeable and the 96Zr metal isotope emits beta particles into the battery to provide a charging benefit.

12. A secondary battery according to claim 8 wherein the Zirconium of at least one of the anode and the cathode comprises a compound comprising Zirconium.

13. A secondary battery according to claim 8 wherein at least one of the anode and the cathode comprises a sponge plate having large surface areas for increased ion storage and displacement.

14. A secondary battery according to claim 13 wherein the sponge plates is associated with nanotubes.

15. A secondary battery according to claim 14 wherein the nanotubes are selected from the group consisting of nanotubes embedded in the sponge plate and nanotubes carried on the surface of the sponge plate.

16. A secondary battery according to claim 8 wherein at least one of the anode and the cathode comprises a nanoscale textured surface comprising an enlarged area for increased ionic storage and displacement.

17. A secondary battery wherein the anode and the cathode each comprise at least one terminal doped with Cobalt.

18. A secondary battery comprising: at least one anode; at least one cathode; at least one separator; at least one liquid electrolyte comprising Bismuth.

19. A secondary battery according the claim 18 wherein the liquid electrolyte comprises a colloidal suspension and further comprises nanotubes to increase ionic flow.

20. A secondary battery according to claim 19 wherein the nanotubes are selected from the group consisting of Carbon and Zirconium nanotubes.

21. A secondary battery according to claim 18 wherein the electrolyte comprises nanosized powders.

22. A secondary battery according to claim 21 wherein the nanosized powder is selected from the group consisting of activated Carbon nanosized powder and Zirconium nanosized powder.

23. A secondary battery according to claim 18 wherein the at least one liquid electrolyte comprises two Bismuth electrolytes contained respectively in separate sealed chambers in the battery.

24. A secondary battery according to claim 23 wherein one electrolyte comprises Bismuth in an ionic oxidation state of +3 contiguous with the cathode and the other electrolyte comprises Bismuth in an ionic oxidation state of +5 contiguous with the anode.

25. A secondary battery cell comprising: two electrolytes respectively disposed in sealed chambers, each electrolyte comprising a colloidal suspension comprising Bismuth and nanotubes, the two electrolytes having different Bismuth ionic oxidation states; a cathode plate comprising Zirconium and nanotubes, the cathode plate further comprising a large exposed surface area to increase ionic storage and flow; an anode plate comprising Zirconium and nanotubes, the anode plate further comprising a large surface area to increase ionic storage and flow; a separator disposed between the cathode plate and the anode plate, the separator being comprised of dielectric material permeable to ionic flow and further comprising nanotubes to enhance ionic flow.

26. A secondary battery comprising an anode, a cathode, a separator and electrolyte, at least one of which comprises aligned nanotubes.

27. A method of making a secondary battery by providing an anode, a cathode, a separator and electrolyte and associating aligned nanotubes with at least one of the anode, the cathode, the separator and the electrolyte.
